(19) United States
(12) Patent Application Publication
(10) Pub. No.: US 2023/0286607 A1
(43) Pub. Date: Sep. 14, 2023

(54) ELECTRIC MOTORCYCLE WITH SWING ARM MOUNTED MOTOR

(71) Applicant: Super73, Inc., Irvine, CA (US)

(72) Inventors: Erik Dunshee, Irvine, CA (US); Legrand Crewse, Irvine, CA (US)

(21) Appl. No.: 18/121,587

(22) Filed: Mar. 14, 2023

Related U.S. Application Data
(60) Provisional application No. 63/319,698, filed on Mar. 14, 2022.

(51) Int. Cl. B62K 11/02; B62K 25/28; B62J 43/16

(52) U.S. Cl. CPC B62K 11/02; B62J 43/16; B62K 25/283; B62K 2204/00

(57) ABSTRACT

An electric motorcycle is provided. The electric motorcycle includes a frame, a battery, a motor electronically connected to the battery, a chain connecting the motor to a rear wheel, and a dual-sided swing arm configured to maintain the rear wheel, the dual-sided swing arm comprising a right side swing arm spar and a left side swing arm spar, the dual-sided swing arm joined to the frame at a pivot point forward of the rear wheel. The motor is positioned within the dual-sided swing arm at a motor location between the pivot point and the rear wheel.

This application claims the benefit of U.S. Provisional Pat. Application Serial No. 63/319,698, entitled “Electric Motorcycle with Swing Arm Mounted Motor,” inventors Erik Dunshee, et al., filed Mar. 12, 2022, the entirety of which is incorporated herein by reference.

### BACKGROUND OF THE INVENTION

### Field of the Invention

The present invention relates generally to the art of electric motorcycles, and more specifically to an electric motorcycle with a notably small frame employing a unique rear swing arm arrangement.

### Description of the Related Art

Motorized bicycles have been available for decades. Newer devices, called electric motorbikes, employ electronic power in the form of a battery and can also be operated using a set of pedals in many instances. Gasoline powered motorcycles are also well known, but recent attention in environmental concerns, such as minimizing pollution, has given rise to an enhanced interest in electric motorcycles.

Certain existing electric motorcycles tend to have long wheelbases which are difficult to navigate for smaller riders. Engines in such electric motorcycles include have been located in positions typically within the electric motorcycle frame, and generally in middle region of the electric motorcycle when measured from forward wheel hub to rear wheel hub. Such an arrangement can require drive mechanisms that are relatively large, such as lengthy chains or drive shafts that can be cumbersome, and in the case of a chain, can have issues with maintaining appropriate tension and/or contacting the rider. Smaller drive arms and/or mechanisms can be desirable and more efficient in certain cases.

Further, users at times wish to use different components depending on terrain, circumstance (racing, off-roading, normal street use, etc.) Interchangeability of components can be advantageous, and many existing electric and gasoline motorcycles have limited interchangeability.

It would be advantageous to offer an electric motorcycle design that provides advantages over existing designs.

### SUMMARY OF THE INVENTION

According to one embodiment, there is provided an electric motorcycle comprising a frame, a battery, a motor electronically connected to the battery, a chain connecting the motor to a rear wheel, and a swing arm configured to maintain the rear wheel, the swing arm joined to the frame at a pivot point forward of the rear wheel. The motor is positioned within the swing arm at a motor location between the pivot point and the rear wheel.

In one embodiment of the present design, a spring joins the frame to the swing arm. The swing arm may be formed of two swing arm spars, wherein each swing arm spar is on a different side of the electric motorcycle. The design may further include a fast charging unit connected to the battery, and the wheel base of the electric motorcycle may not exceed 52 inches. A set of handlebars may be joined to the frame by modular detachable hardware.

In another embodiment, there is provided an electric motorcycle comprising a frame, a battery mounted within the frame, a motor electronically connected to the battery, a chain connecting a sprocket provided with the motor to a hub of a rear wheel, and a dual-sided swing arm comprising a right side swing arm spar and a left side swing arm spar, the dual-sided swing arm maintaining the hub and rear wheel and joined to the frame at a pivot point forward of the rear wheel.

A handlebar display mount and/or a fingerprint reader configured to provide keyless access to the electric motorcycle may be provided. At least one swing arm spar may include an access door providing access to the motor.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 is a side view of an embodiment of an electric motorcycle in accordance with the present design;

FIG. 2 is a front three quarter perspective representation of an embodiment of the current design;

FIG. 3 shows a rear view of an embodiment of the present design;

FIG. 4 is a rear perspective view of an embodiment of the present design;

FIG. 5 illustrates a front view of an embodiment of the present design;

FIG. 6 is a view of the modular, detachable stem, handlebar mount display, and fingerprint reader of an embodiment of the present design;

FIG. 7 is a side view of the swing arm arrangement;

FIG. 8 illustrates a view of the swing arm, spring, motor, and pivot point of an embodiment of the present design;

FIG. 9 shows an exploded view of portions of the design including the motor and swing arm spars;

FIG. 10 is a representation of the overall architecture of an embodiment of the present design;

FIG. 11 illustrates an embodiment of the modular detachable stem;

FIG. 12 is an alternate embodiment of the modular detachable stem; and

FIG. 13 is an overall representation of an embodiment of the present design.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

The present design is an electric motorcycle that includes a unique swing arm design wherein the pivot point is at the forward end of the swing arm, the engine positioned aft of the pivot point and within a movable part of the swing arm. The design includes a modular or detachable stem element such that handlebars can be quickly and easily swapped out, a handlebar display mount, and a fingerprint reader to provide an additional level of access for the rider. Of particular note is the reduced wheelbase, in one embodiment an approximate or exactly 51 inch wheel base employing 15 inch wheels. In one embodiment, the wheel base does not exceed 52 inches. The design provides a chain drive with a relatively large wheel hub, providing enhanced speed capabilities as compared against typical bicycle style chain arrangements. Further, the electric motorcycle features fast charging capabilities.

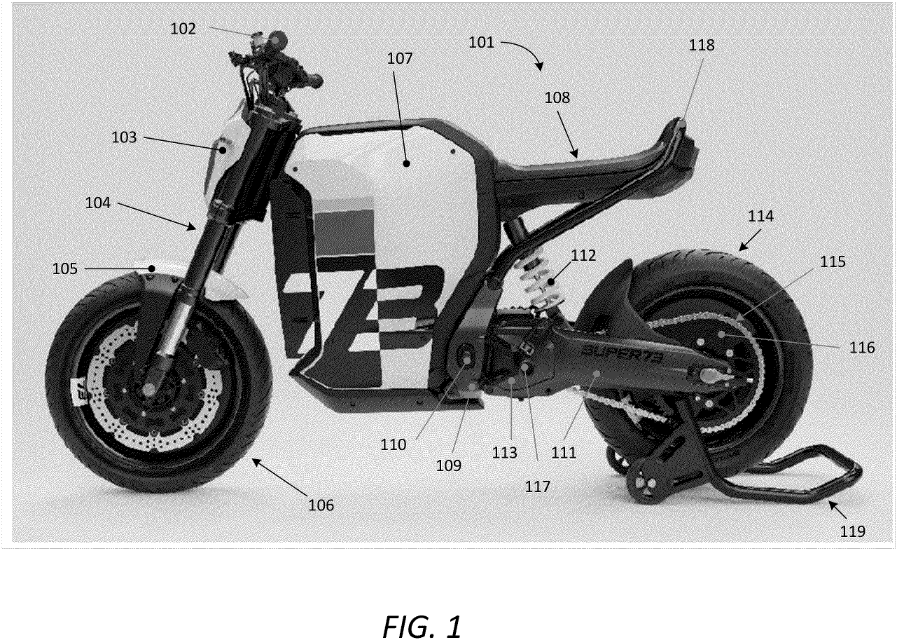

FIG. 1 is a side view of one embodiment of the electric motorcycle 101. Shown in this view are handlebars 102, forward facia plate 103, fork 104, front fender 105, and front wheel 106, as well as body 107, seat 108, pivot plate 109, pivot point 110, swing arm 111, spring 112, and access door 113. Rear wheel 114 includes hub 116 and receives chain 115, where chain 115 interfaces with the motor (not shown in this view) to drive the rear wheel 114. Foot pedal 117 is shown, and frame 118 is shown, with other frame components obscured in this view by body 107. FIG. 1 includes a stand 119 that is for display purposes.

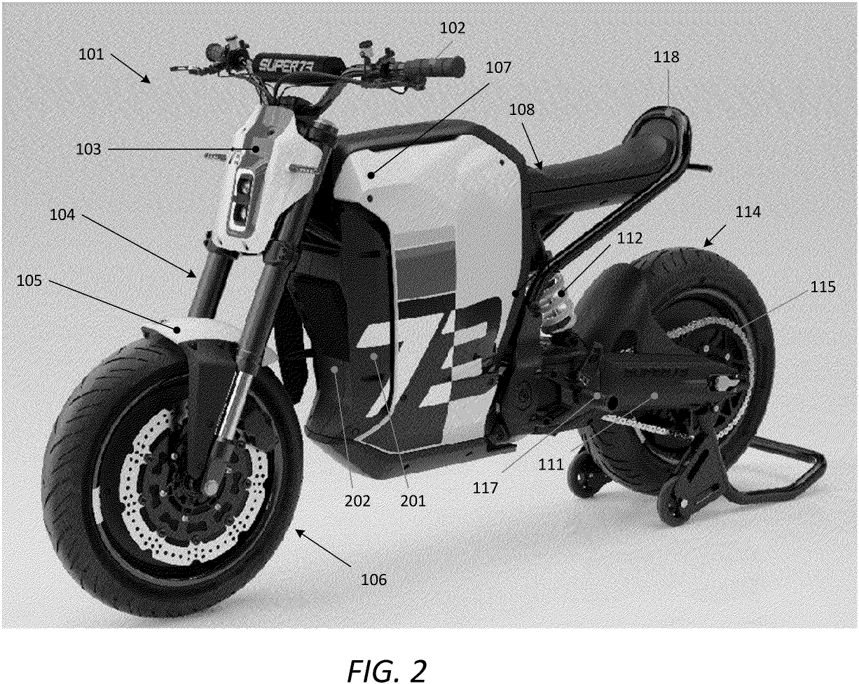

FIG. 2 is a perspective representation of the design, where handlebars 102, front facia plate 103, front fork 104, front fender 105, and front wheel 106 are viewable. Also clear in this view are seat 108, body 107, frame 118, rear wheel 114, and chain 115. Swing arm 111 and spring 112 are viewable. Forward cowling 201 is shown with internal component 202 also viewable at the angle presented.

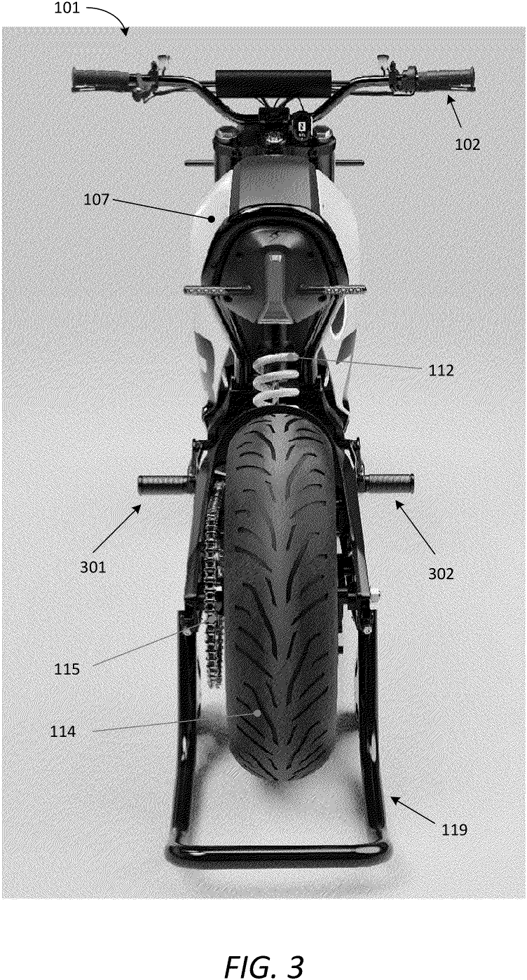

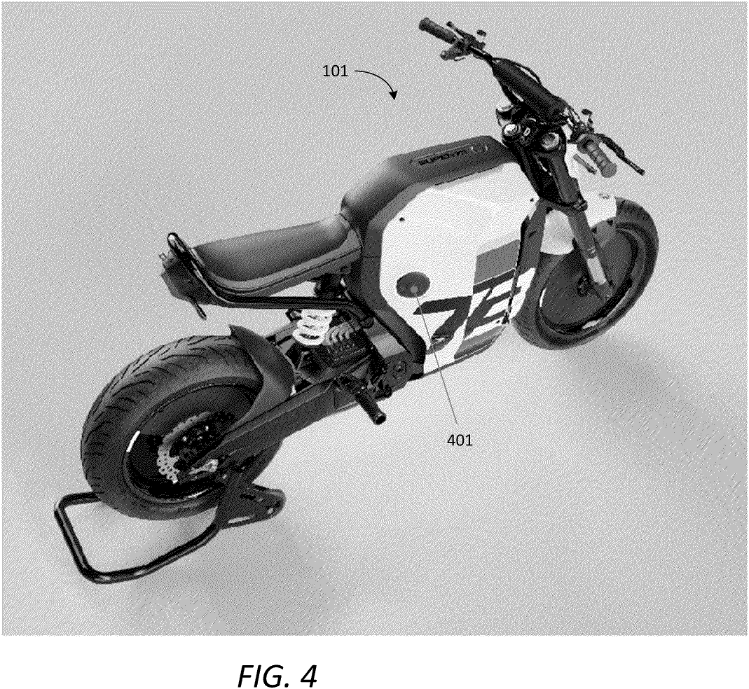

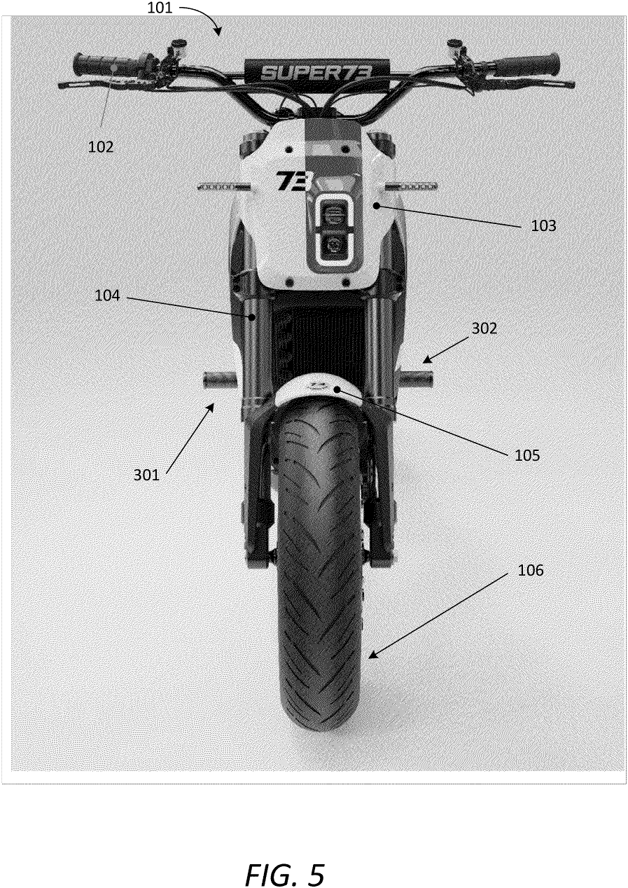

FIG. 3 is a rear view of the design showing foot pegs 301 and 302. FIG. 4 is a perspective three quarter rear view of the design. FIG. 4 shows fast charging access port 401. FIG. 5 is a front view of the design.

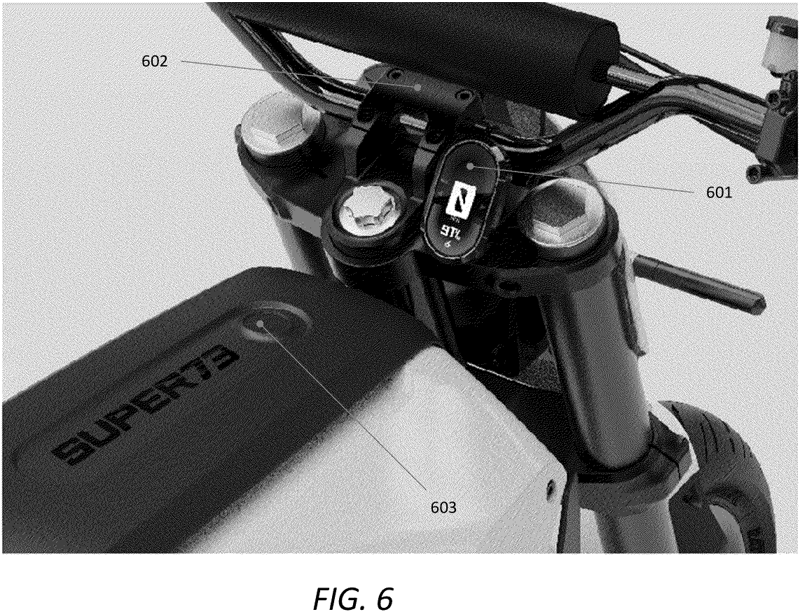

FIG. 6 is a view of the stem assembly including modular stem 601 which is detachable such that the user can employ different handlebars when desired. In essence, the user may release the upper element such as by unscrewing the upper element or otherwise releasing the upper element, swap in a different set of handlebars for the existing handlebars, and may then secure the new handlebars using by, for example, screwing down the upper element.

Handlebar mount display 602 can display relevant information, including values such as current speed in appropriate units, battery charge level, usage of power under current conditions (e.g., zero percent or very low at idle, 100 per cent or near that at maximum throttle/power use), remaining miles when driving under current conditions, odometer, charge level (when being charged), and so forth. Various screens may be provided, i.e., a current speed screen and a separate charging screen, with each screen selectable by the user. Also presented is a fingerprint reader 603, providing a secondary or emergency means for accessing functionality of the device, such as turning the vehicle on, accessing charging capability, and so forth.

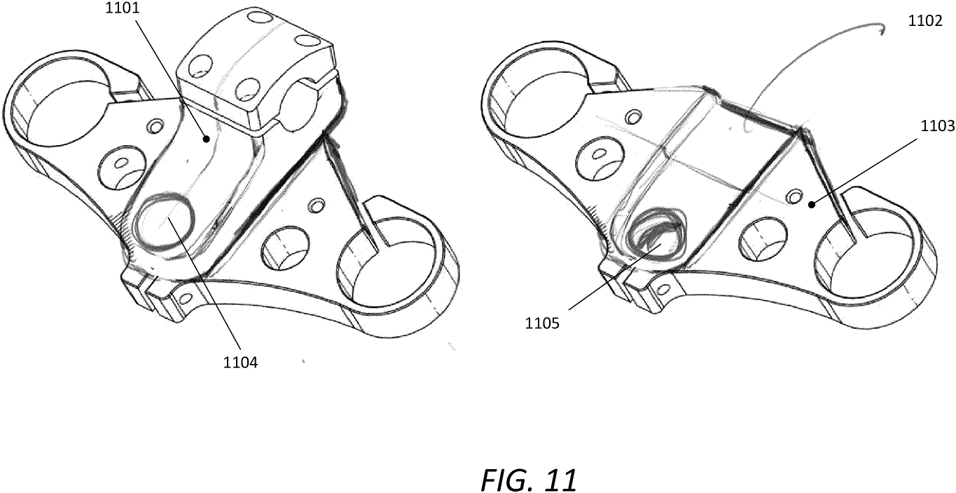

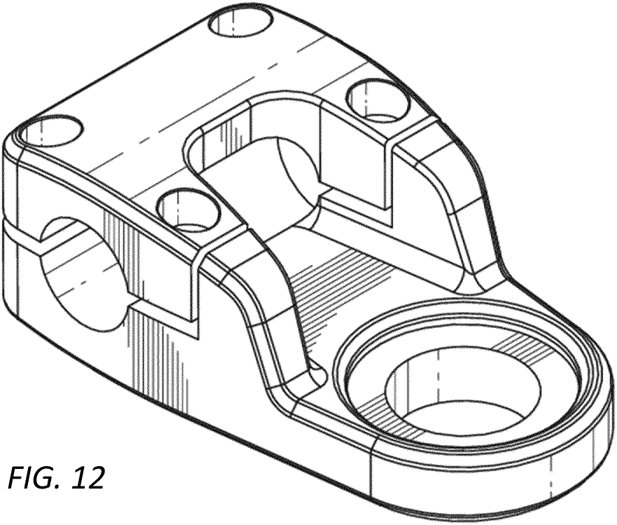

The modular stem is illustrated in further detail in FIGS. 11 and 12. From FIG. 11, modular detachable stem 1101 is located in opening 1102 of triple crown element 1103. Thus the modular detachable stem 1101 can be completely removed and a different set of handlebars having different dimension can be provided. Alternate detachable stem elements, differing in shape from modular detachable stem 1101, can be provided to allow for a different handlebar position or a different handlebar diameter without the need to replace or alter triple crown element 1103. Modular detachable stem is attachable by a properly sized bolt passing through opening 1104 in modular detachable stem 1101 and opening 1105 in triple crown element 1103. FIG. 12 shows a representation of modular detachable stem 1101.

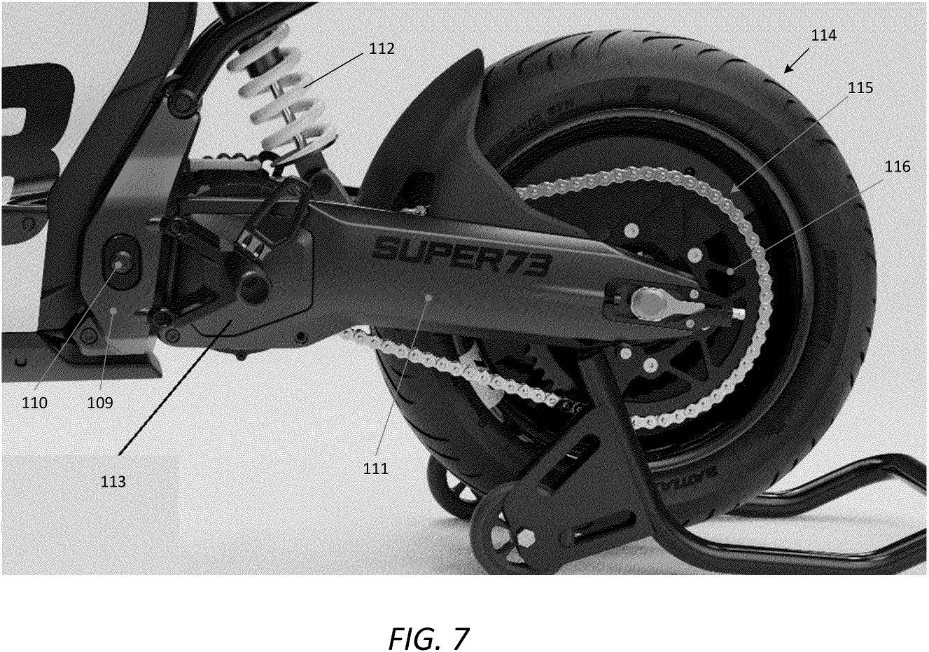

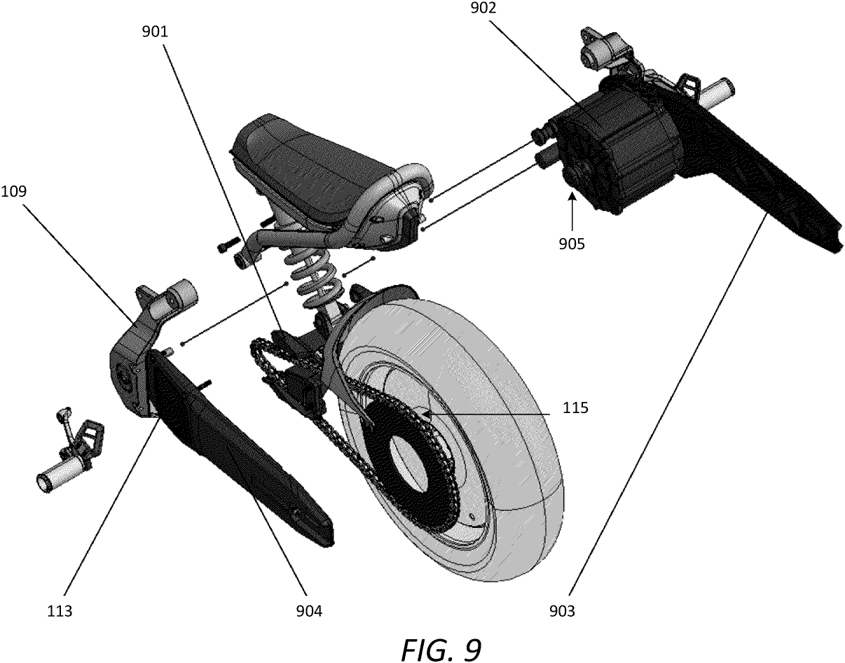

FIG. 7 illustrates a side view of an embodiment of a swing arm having an access panel and a motor provided therein. The swing arm 111 shown in FIG. 7 attaches to the rear wheel hub 116 on one end and the frame beneath pivot plate 109 on the other. Swing arm 111 pivots about pivot point 110. The chain 115 provided goes around a relatively large rear wheel hub 116 and thus passes from a small radius forward circular element attached to and driven by a motor (not shown in this view) to the relatively large rear wheel hub 116, providing increased speed for a relatively low motor output. The radial difference in the front and rear of chain 115 is shown in FIG. 9. In the present design, the motor is positioned within swing arm 111 in the view shown, accessible by an access panel, where the spring 112 above swing arm 111 joins the swing arm at the top of swing arm 111. Motor 902 may be maintained in any reasonable manner within swing arm 111, and may include support or connection members, typically to both sides of swing arm 111. From front to rear, pivot point 110 represents the attachment point to the frame, the motor 902 within swing arm 111, the remainder of the swing arm 111, and a connection to rear wheel hub 115. While access door 113 is pictured on one side of electric motorcycle 101, a similar access door can be provided on the opposite side. An exploded view of the device, shown in FIG. 9, illustrates swing arm 111 being made up of components, such as two swing arm spars, and access doors can be located on one or both spars.

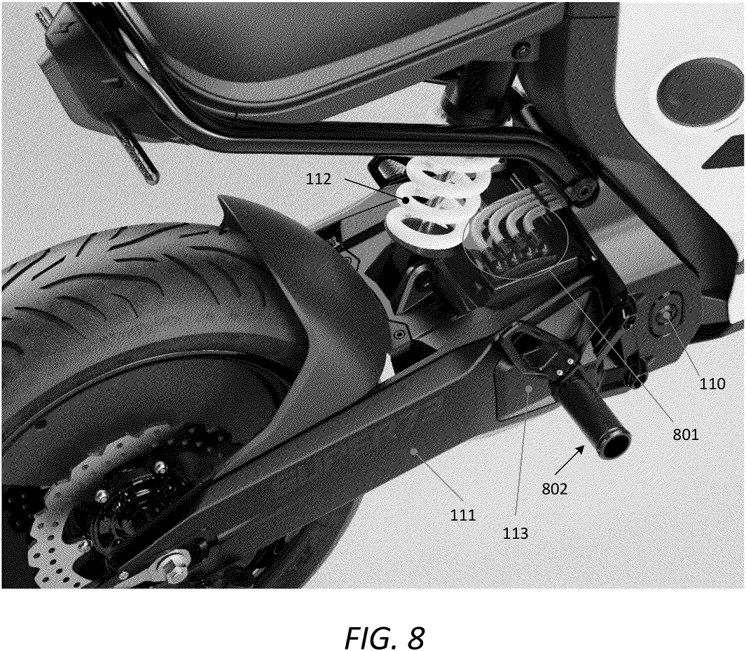

FIG. 8 shows a top view including electrical connections 801 from the battery (not shown) and connecting to the motor. Electrical connections may vary but typically include power, such as positive and negative connections from the battery and at least one control connection providing control to the motor. Further connections may be provided such as a return control connection for determining relevant parameters such as temperature or other values. The top of swing arm 111 is shown, as is pivot point 110 and spring 112, as well as right foot pedal 802. No chain is provided on the right side in this embodiment. FIG. 9 is an exploded view of an embodiment of the design, including pivot plate 109, central swing arm truss 901, and motor 902 mounted on right outer swing arm spar 903. Left outer swing arm spar 904 is shown, having in this embodiment removable access panel 113 to provide for maintenance of the sprocket 905, chain 115, and motor 902 as well as other internal components. In this manner, with the motor 902 positioned aft of the pivot point 110 within swing arm 111, the wheel base is shorter than traditional gasoline powered and currently available electric motorcycles. The result in one embodiment is a wheelbase on the order of 51 inches, with 15 inch front and rear wheels.

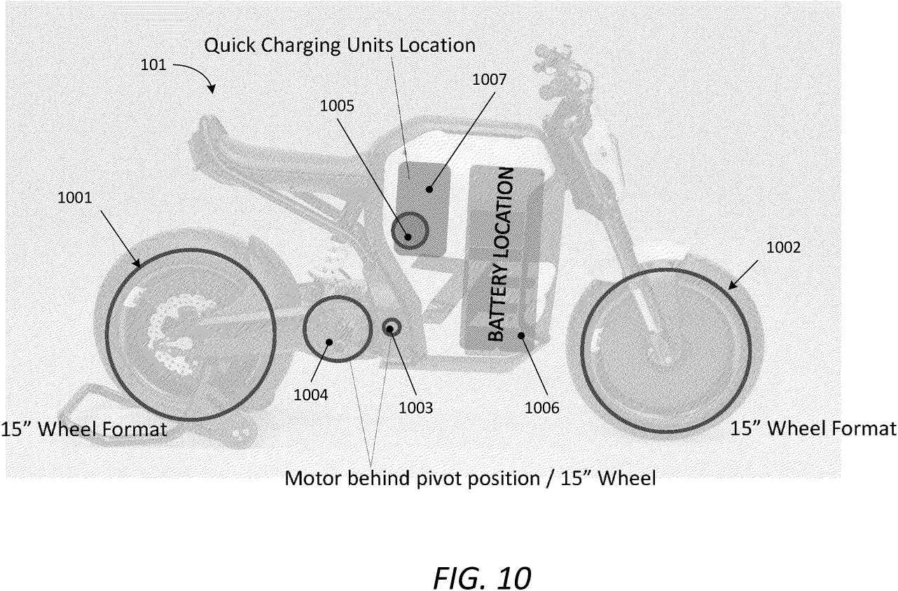

FIG. 10 is a view of the design showing certain internal and external components. Rear wheel representation 1001 is a 15 inch format, as is front wheel 1002The pivot point is shown as point 103, while the motor location 1004 is presented behind the pivot point. Quick charge element 1007 is shown with a quick charge opening indicated at point 1005. The battery is located in the representation of element 1006.

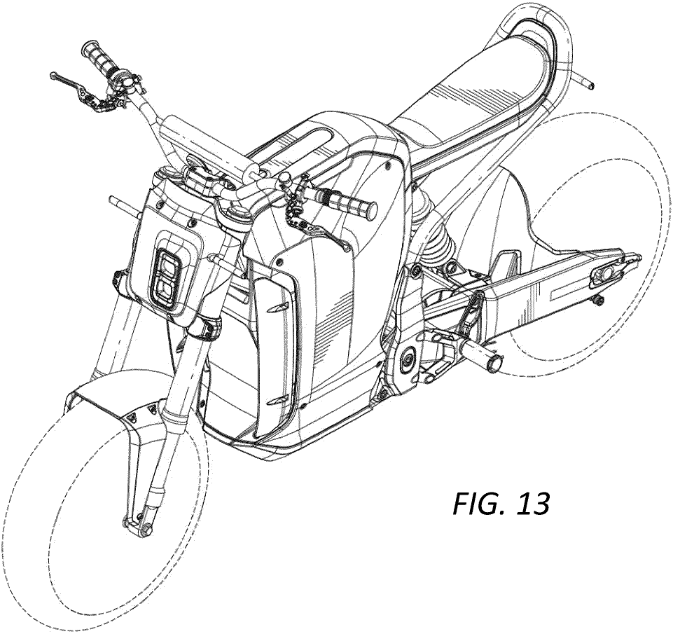

FIG. 13 illustrates an embodiment of the overall electric motorcycle design.

According to one embodiment, there is provided an electric motorcycle comprising a frame, a battery, a motor electronically connected to the battery, a chain connecting the motor to a rear wheel, and a swing arm configured to maintain the rear wheel, the swing arm joined to the frame at a pivot point forward of the rear wheel. The motor is positioned within the swing arm at a motor location between the pivot point and the rear wheel.

In one embodiment of the present design, a spring joins the frame to the swing arm. The swing arm may be formed of two swing arm spars, wherein each swing arm spar is on a different side of the electric motorcycle. The design may further include a fast charging unit connected to the battery, and the wheel base of the electric motorcycle may not exceed 52 inches. A set of handlebars may be joined to the frame by modular detachable hardware.

In another embodiment, there is provided an electric motorcycle comprising a frame, a battery mounted within the frame, a motor electronically connected to the battery, a chain connecting a sprocket provided with the motor to a hub of a rear wheel, and a dual-sided swing arm comprising a right side swing arm spar and a left side swing arm spar, the dual-sided swing arm maintaining the hub and rear wheel and joined to the frame at a pivot point forward of the rear wheel.

A handlebar display mount and/or a fingerprint reader configured to provide keyless access to the electric motorcycle may be provided. At least one swing arm spar may include an access door providing access to the motor.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. An electric motorcycle comprising:
a frame;
a battery;
a motor electronically connected to the battery;
a chain connecting the motor to a rear wheel; and
a dual-sided swing arm configured to maintain the rear wheel, the dual-sided swing arm comprising a right side swing arm spar and a left side swing arm spar, the dual-sided swing arm joined to the frame at a pivot point forward of the rear wheel;
wherein the motor is positioned within the dual-sided swing arm at a motor location between the pivot point and the rear wheel.

2. The electric motorcycle of claim 1, further comprising a spring joining the frame to the dual-sided swing arm.

3. The electric motorcycle of claim 1, wherein the rear wheel is attached to a hub configured to receive the chain.

4. The electric motorcycle of claim 1, further comprising a fast charging unit connected to the battery.

5. The electric motorcycle of claim 1, wherein a wheel base of the electric motorcycle does not exceed 52 inches.

6. The electric motorcycle of claim 1, further comprising a set of handlebars joined to the frame by modular detachable hardware.

7. The electric motorcycle of claim 1, further comprising at least one of a handlebar display mount and a fingerprint reader configured to provide keyless access to the electric motorcycle.

8. The electric motorcycle of claim 1, wherein at least one of the right side swing arm spar and the left side swing arm spar comprises an access door providing access to the motor.

9. An electric motorcycle comprising:
a frame;
a battery mounted within the frame;
a motor electronically connected to the battery;
a chain connecting a sprocket provided with the motor to a hub of a rear wheel; and
a dual-sided swing arm comprising a right side swing arm spar and a left side swing arm spar, the dual-sided swing arm maintaining the hub and rear wheel and joined to the frame at a pivot point forward of the rear wheel.

10. The electric motorcycle of claim 9, further comprising a spring joining the frame to the dual-sided swing arm.

11. The electric motorcycle of claim 9, wherein the rear wheel is attached to a hub configured to receive the chain.

12. The electric motorcycle of claim 9, further comprising a fast charging unit connected to the battery.

13. The electric motorcycle of claim 9, wherein a wheel base of the electric motorcycle does not exceed 52 inches.

14. The electric motorcycle of claim 9, further comprising a set of handlebars joined to the frame by modular detachable hardware.

15. The electric motorcycle of claim 9, further comprising at least one of a handlebar display mount and a fingerprint reader configured to provide keyless access to the electric motorcycle.

16. The electric motorcycle of claim 9, wherein at least one of the right side swing arm spar and the left side swing arm spar comprises an access door providing access to the motor.
